(19) United States
(12) Patent Application Publication
(10) Pub. No.: US 2006/0152075 A1
(43) Pub. Date: Jul. 13, 2006

(54) Pressure regulator module for a motor vehicle pneumatic braking system

(75) Inventors: Hermann Goebels, Sheffield Village, OH (US); Richard Beyer, Westlake, OH (US)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge Gmbh, Muenchen (DE)

(21) Appl. No.: 10/524,291

(22) PCT Filed: Aug. 11, 2003
(86) PCT No.: PCT/EP03/08884

§ 371 Date: Sep. 22, 2005

(30) Foreign Application Priority Data
Aug. 12, 2002 (DE) 102 36 922.4

(51) Int. Cl. B60T 8/36

(52) U.S. Cl. 303/119.1; 303/3; 303/15

(57) ABSTRACT

The invention concerns a pressure regulator module for a motor vehicle pneumatic braking system, in particular a utility vehicle. The pressure regulator module is used to control or regulate on the basis of the wheel slip braking pressure applied on two separate working connections and comprises a two-way valve assembly consisting of a relay valve for each conduit. The invention is characterized in that, only one pressure regulating valve in the form of a 3/2-way valve is assigned to the control inputs of each of the relay valves, thus providing a pressure regulating valve easy and economical to manufacture.

### BACKGROUND AND SUMMARY OF THE INVENTION

The invention relates to a pressure regulator module for a motor vehicle pneumatic braking system, particularly of a utility vehicle, for the wheel-slip-dependent controlling or regulating of braking pressures applied to two separate working connections, such a pressure regulator module including a two-way valve assembly having one relay valve for each conduit, one solenoid control valve respectively being assigned to the control inputs of each of the two relay valves.

Such pressure regulator modules are used for controlling and regulating the braking pressure at the vehicle wheels in order to prevent the wheels from locking during braking (antilock system, ABS) or to prevent a wheel slip during an accelerating operation (wheel slip control system, ASR).

Known antilock systems consist of wheel speed sensors, an electronic controlling and regulating unit, as well as the pressure regulator modules. In this case, each individually regulated wheel requires a wheel speed sensor and a pressure regulator module, as well as a connection to the electronic controlling and regulating unit. The ASR uses the same structural members as the ABS, but beyond that has an additional valve for building-up braking pressure at a spinning wheel independently of the operation of the brake pedal. The wheel-related wheel speed sensor is arranged on the respective vehicle wheel in order to measure the momentary wheel speed and sends a corresponding electrical signal to the controlling and regulating unit, which unit analyzes the signals received from the wheel speed sensors of the additional vehicle wheels as well as other parameters, such as the vehicle speed and the vehicle acceleration. The unit then decides whether one or more wheels slip beyond defined values during braking or accelerating. For avoiding an excessive wheel slip, the pressure regulator modules of the controlling and regulating unit are then controlled in order to reduce, increase, or maintain the braking pressure in the concerned vehicle wheels. Furthermore, it is known to combine the pressure regulator modules of the wheel of one axle (or of one axle side) to a single, multi-conduit pressure regulator module in order to save components and installation space.

A 2-conduit pressure regulator module of the above-mentioned type is known from German Patent document DE 42 27 084 A1, in which case, according to a first embodiment of the reference, a wheel-slip-dependent regulating of the braking pressure is provided in the event that the wheels of one axle lock during braking (ABS). The valve unit in each case comprises a solenoid control valve in the form of a 2/2-way valve, which is assigned to a relay valve and either blocks the control input of the assigned relay valve or connects it with the output of a bleeder valve connected in front of it. The bleeder valve is connected on the input side with a control pressure and with a bleeding system. Since only one bleeder valve is present, a pressure buildup or pressure reduction, which in each case acts only in the same direction, can take place in the two brake cylinders, while pressure changes in the opposite direction, such as a pressure buildup in one brake cylinder and a pressure reduction in the other brake cylinder, cannot take place. By way of a respective shutting of the 2/2-way valves, however different braking pressures can be controlled. A total of three solenoid control valves are, therefore, provided for controlling the two relay valves.

According to another embodiment of the DE '084 reference, a pressure regulator module is disclosed which, in addition to the ABS during the braking, has an ASR which prevents the slipping of the wheels when starting or accelerating. According to this embodiment, five solenoid control valves are present for controlling the two relay valves.

U.S. Patent document U.S. Pat. No. 6,371,573 B1 discloses a single-conduit braking system, in which a relay valve is controlled by a 3/2-way valve.

It is an object of the present invention to further develop a pressure regulator module of the above-mentioned type such that, while its functionality is high, it can be produced in a simple and cost-effective manner.

According to the invention, this object is achieved by providing a pressure regulator module for a vehicle pneumatic braking system, particularly of a utility vehicle, for the wheel-slip-dependent controlling or regulating of braking pressures applied to two separate working connections. The module includes a two-conduit valve unit having one relay valve for each conduit. In each case, only one solenoid control valve, constructed as a 3/2-way valve, is assigned to the control inputs of each of the two relay valves.

As a result of the corresponding controlling of the two 3/2-way control valves, the braking pressure at the working connections in the sense of a wheel-related ABS system can be advantageously individually reduced, maintained or raised. In addition to the ABS, a wheel slip control system (ASR) can also be advantageously implemented. With respect to an embodiment of German Patent document DE 42 27 084 A1, which also contains wheel-individual ABS and ASR functions, however, instead of five solenoid control valves, only three are provided. The invention therefore offers savings with respect to the installation space, the weight and the cost.

In addition, by using this valve arrangement according to the invention, an expanded ABS can also be implemented, in which the vehicle stability is increased also without the presence of a braking initiated by the driver by the wheel-individual automatic controlling-in of braking pressure in order to prevent, for example during a cornering, by means of a targeted braking, a lateral rolling-over of the vehicle. Furthermore, in both cases the cabling expenditures are also lower. In addition, because of the fewer number of solenoid control valves, fewer drivers or interfaces are required.

The 3/2 valves used are simply constructed solenoid control valves, in the case of which, by way of 2 control positions, a pressure in the sense of a 2-way function can either be built up or reduced. Relative to the controlling of the relay valves, this means that, for example, in the non-energized condition of the 3/2-way valve, a control pressure is switched through unchanged to the control connection of the assigned relay valve and, in the energized case, the control connection of the relay valve is connected with a bleeding connection while the control pressure is simultaneously blocked. By use of a special electric control mode, in addition to the pressure buildup and the pressure reduction, a pressure-holding function can be implemented, for example, in that, for holding the pressure, the electronic control system controls the 3/2-way control valves at a higher frequency and with a corresponding timing ratio (switch-on to switch-off time). As a result, the control pressure of the relay valve is also timed, in which case the relay control piston remains in its center position because of its hysteresis and, therefore, in the holding function. As a result, with respect to the electronic control system, only a simple electric switching function of the current is required, for example, by way of a simple electronic switching transistor, and no high-expenditure regulating of current as in the case of a proportional valve according to another embodiment of German Patent document DE 42 27 084 A1.

Relative to the extent of the functions, the invention therefore achieves the implementation of a pressure regulator module with few and with cost-effective control valves, respectively.

As a result of the measures indicated in the subclaims, advantageous further developments and an improvement of the invention can be achieved.

According to a preferred embodiment of the invention, the two 3/2-way valves are controlled independently of one another by an electronic controlling and regulating unit and, on the input side, are connected with the control pressure and, on the output side, are connected in each case with the control input of the assigned relay valve and with the bleeding system.

In a preferred further development, in the non-energized spring-loaded, normal position, the two 3/2-way valves switch the control pressure through to the control inputs of the relay valves and, in the energized position, switch the control inputs of the relay valves through to the bleeding system.

In a particularly preferable manner, for keeping the pressure at the working connection of the respective conduit, the assigned solenoid control valve is alternately switched back and forth into the pressure buildup and pressure reduction position via the controlling and regulating unit. As a result of the briefly alternating pressure buildup or pressure reduction, a quasi-constant pressure is reached in a brake cylinder connected with the corresponding working connection without requiring additional measures or components for this purpose.

According to particularly preferable measures, the additional solenoid control valve, is formed by another 3/2-way valve which is controlled by the electronic controlling and regulating unit, and which is connected on the input side with the control pressure and on the output side with the inputs of the two solenoid control valves and with the compressed-air reservoir. In the non-energized spring-loaded normal position, the additional solenoid control valve can then switch the control pressure through to the inputs of the two solenoid control valves and, in the energized position, can switch the inputs of the two solenoid control valves through to the compressed-air reservoir.

In particular, the additional solenoid control valve is operated independently of the control pressure and as a function of a wheel slip occurring during the acceleration by means of the regulating and controlling unit. Independently of an operation of the service brake valve, the brake cylinders can, therefore, be acted upon by pressure from the compressed-air reservoir in order to avoid spinning during an acceleration operation, whereby the automatic wheel slip control is implemented.

The additional solenoid control valve is preferably integrated in a housing accommodating the valve unit. Furthermore, the additional solenoid control valve may be arranged outside the housing accommodating the remaining valve unit consisting of the two relay valves and the assigned solenoid control valves and can be constructed to be connectable thereto. In this case, it is contemplated to retrofit a pressure regulator module according to the first alternative of the invention comprising only the antilock function in a simple and rapid manner such that it additionally comprises an automatic slip control. This results in a cost-effective modular design since, based on a basic module consisting of two relay valves and two solenoid control valves, pneumatic braking systems with an ABS function, as well as those with an ABS and an ASR function can be implemented.

The center axes of the two relay valves of the valve unit are preferably arranged coaxially and horizontally. This permits a very compact type of construction with only a single central bleeding connection.

### BRIEF DESCRIPTION OF THE DRAWINGS

Embodiments of the invention are illustrated in the drawings and will be explained in detail in the following description.

FIG. 1 is a schematic representation of a 2-conduit pressure regulator module of the invention according to a preferred embodiment;

FIG. 2 is a braking pressure-time diagram for illustrating an antilock braking system having the pressure regulator module of FIG. 1;

FIG. 3 is a schematic representation of a 2-conduit pressure regulator module of the invention according to another embodiment;

FIG. 4 is a diagram for illustrating a wheel slip control system having the pressure regulator module of FIG. 3; and

FIG. 5 is a schematic representation of a 2-conduit pressure regulator module of the invention according to yet another embodiment.

### DETAILED DESCRIPTION OF THE DRAWINGS

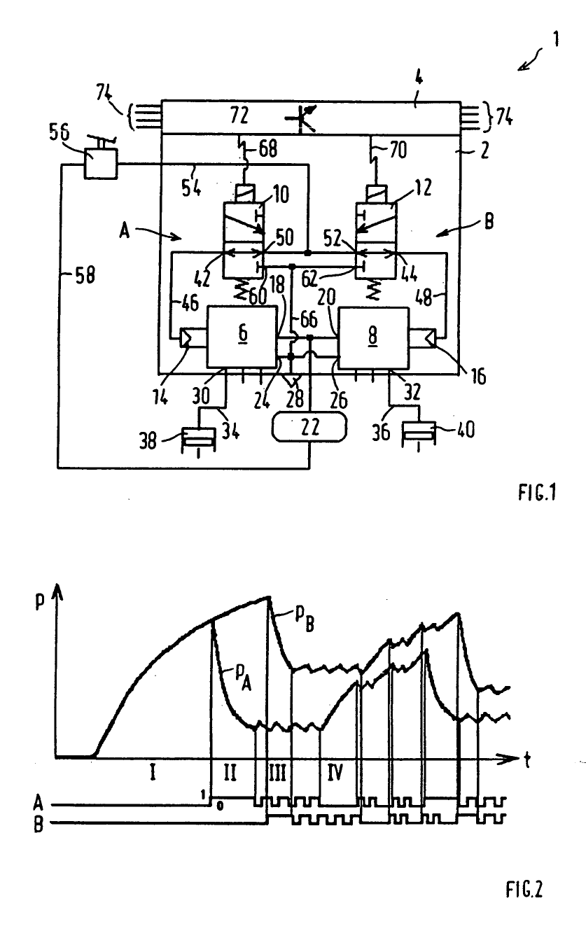

In FIG. 1, reference number 1 indicates a preferred embodiment of a pressure regulator module which, according to the invention, is constructed as a 2-conduit pressure regulator module and includes a valve unit 2 as well as an electronic unit 4 directly connected therewith mechanically and electrically. According to the preferred embodiment, the pressure regulator module 1 is integrated in a pneumatic braking system of a utility vehicle.

The valve unit 2 has two separate pressure regulator conduits A and B, which each include a separate relay valve 6, 8 and a solenoid control valve 10, 12 assigned to the latter, respectively. The pneumatic control input 14 of the relay valve 6 of conduit A is monitored by the assigned solenoid control valve 10, which is in the form of a 3/2-way valve. The pneumatic control input 16 of the relay valve 8 of conduit B is monitored by another solenoid control valve 12 which is also in the form of a 3/2-way valve. The two solenoid control valves 10, 12 have identical constructions and wirings.

Each of the relay valves 6, 8 has several connections, of which one connection 18, 20 respectively is connected with a compressed-air reservoir 22 and another output 24, 26 is connected with a bleeding system 28. Furthermore, each relay valve 6, 8 has a working connection 30, 32, which is connected by way of one brake line 34, 36, respectively, with a brake cylinder 38, 40 in each case assigned to a vehicle wheel. The two brake cylinders 38, 40 are, preferably, situated on an axle, such as a front, rear or trailer axle. Parallel to the working connection 30, 32, additional working connections may be present, so that also brake cylinders of two separate axles can be regulated jointly for each side.

Of the three pneumatic connections, respectively, of the two solenoid control valves 10, 12, one connection 42, 44 respectively is connected by way of a compressed-air pipe 46, 48 with the control input 14, 16 of the assigned relay valve 6, 8. Another connection 50, 52 respectively of the two solenoid control valves 10, 12 is connected by way of a compressed-air pipe 54 with a service brake valve 56 which, as a function of its operation by the driver, outputs a corresponding control pressure into the compressed-air pipe 54. For this purpose, the service brake valve 56 is supplied by way of another compressed-air pipe 58 with stored pressure from the compressed-air reservoir 22. Finally, a third connection 60, 62 respectively of the solenoid control valves 10, 12 is connected by way of a bleeding pipe 66 to the bleeding system 28.

When the pressure regulator module 1 is used in a trailer vehicle, the control pressure in the compressed-air pipe 54 is caused by way of a compressed-air connection, which can be coupled, from the towing vehicle to the trailer vehicle. From there, the control pressure is, in turn, in a direct or indirect operative connection with the service brake valve 56 actuated by the driver. Correspondingly, the compressed-air reservoir 22 to connections 18, 20, when used in the trailer vehicle, is also the compressed-air reservoir of the trailer vehicle.

According to a spring-actuated and currentless pressure buildup position of the solenoid control valves 10, 12 illustrated in FIG. 1, the latter switch through the control pressure generated directly or indirectly by the service brake valve 56 and present in the compressed-air pipe 54 to the respective control inputs 14, 16 of the assigned relay valves 6, 8. In the energized pressure reduction position, the solenoid control valves 10, 12 connect the respective control input 14, 16 of the relay valve 6, 8 with the bleeding pipe 66 leading to the bleeding system 28. Therefore, without the insertion of additional valves, the two solenoid control valves 10, 12 can connect the control input 14, 16 of the respective relay valve 6, 8 either with the bleeding system 28 or with the control pressure 54.

The solenoid control valves 10, 12 are controlled via one electric line 68, 70, respectively, by an electronic controlling and regulating unit 72. The latter comprises at least one microcomputer, which has a separate intelligence, as well as additional electronic or electric components, which are not described here in detail, and which are capable of processing arriving analog and digital signals.

For this purpose, the electronic controlling and regulating unit 72 has connections 74 for transmitting and receiving analog and/or digital signals and connections 74 corresponding to the number of sensed vehicle wheels for sensor input signals reflecting the rotational wheel behavior. The two solenoid control valves 10, 12 can be controlled independently of one another by the electronic controlling and regulating unit 72, particularly also for raising the pressure in conduit A while simultaneously lowering the pressure in conduit B, or vice-versa. As illustrated in FIG. 1, in addition, the center axes of the two relay valves 6, 8 are arranged coaxially and horizontally.

Based on this background, the following method of operation of the pressure regulator module 1 illustrated in FIG. 1 is obtained.

During a normal service braking, the two solenoid control valves 10, 12 are in the spring-actuated currentless pressure buildup position illustrated in FIG. 1, and the control pressure generated by the service brake valve 56 is switched unhindered by the solenoid control valves 10, 12 through to the control inputs 14, 16 of the two relay valves 6, 8. Proportional to this control pressure, the two relay valves 6, 8 introduce a larger volume of braking pressure from the compressed-air reservoir 22 into the brake cylinders 38, 40. The pressure buildup in the brake cylinders 38, 40 also takes place proportionally to the falling control pressure which is present at the control inputs 14, 16 of the relay valves 6, 8 and controls these such that the braking pressure is reduced directly by way of the output 24, 26 of the respective relay valve 6, 8 connected with the bleeding system 28.

During an ABS-regulated braking, during which the controlling and regulating unit 72 recognizes overbraked wheels with an increased wheel slip, the two conduits A, B containing one solenoid control valve 10, 12 and an assigned relay valve 8, 10, respectively, are controlled separately from one another, and thus the supply of control pressure from the service brake valve 56 to the two relay valves 6, 8 is regulated individually. By means of the pressure regulator module 1 according to the invention, conditions are, for example, templated here in which the control pressure of one relay valve 8 is raised and, simultaneously, the control pressure of the other relay valve 6 is lowered and also different pressure levels are regulated. This is so, for example, when one wheel of the axle is, for example, on ice and the other wheel is on a dry nonskid base.

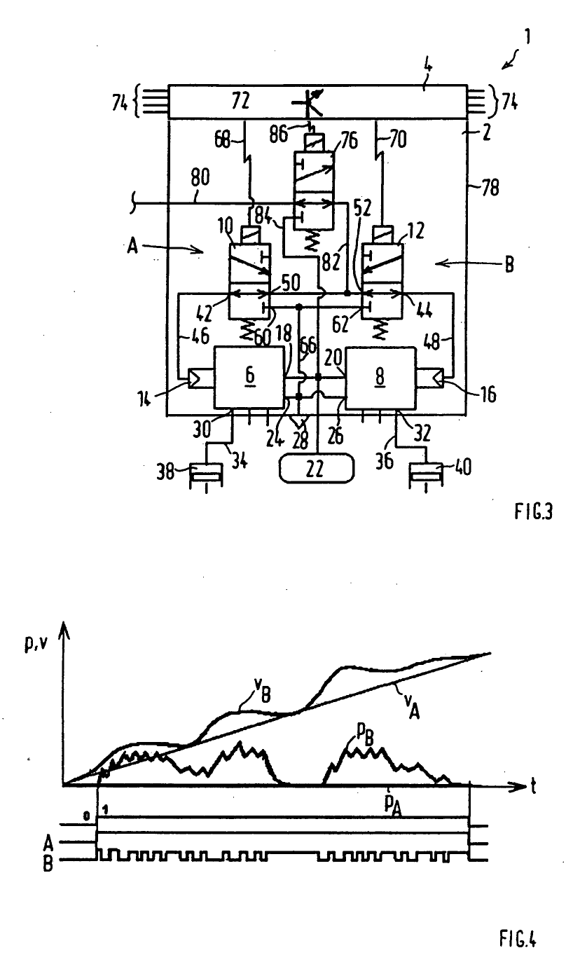

FIG. 2 shows, for example, the braking pressures PA, PB, which are entered over time, in the two conduits A, B or brake cylinders 38, 40 of the axle or axles in the case of a joint pressure regulating during braking with an ABS function. The number 1, which is entered on the bar situated underneath, means that the solenoid control valve 10, 12 assigned to the respective conduit A, B or brake cylinder 38, 40 is energized, and the number 0 means that the corresponding solenoid control valve 10, 12 is non-energized.

As illustrated in FIG. 2, during an initial braking phase I, first the pressure in the two conduits A, B is increased in a uniform manner in that the two solenoid control valves 10, 12 at first remain non-energized, and the control pressure generated by the service brake valve 56 reaches the control inputs 14, 16 of the two relay valves 6, 8 unhindered in order to control proportional and, at first, equally large braking pressures PA, PB into the two brake cylinders 38, 40. When the wheel slip exceeds unacceptable values on the wheel assigned to the conduit A, the braking pressure is first reduced during a phase II in the corresponding brake cylinder in that the assigned solenoid control valve 10 is energized by the controlling and regulating unit 72 and is therefore switched into the pressure reduction position. During a further phase III, the braking pressure PA in the conduit A is held at an approximately constant level in that the solenoid control valve 10 assigned to the conduit A is alternatingly switched back and forth between its pressure buildup position and its pressure reduction position. In this case, the switching points are situated at very brief intervals behind one another so that a quasi-static braking pressure PA, which oscillates about a constant value, is obtained at the assigned brake cylinder, as illustrated in FIG. 2. During phase IV, which follows, the braking pressure p_{A} in the conduit A is raised in order to achieve a braking effect which is as large as possible when the wheel slip is optimal. For this purpose, the solenoid control valve 10 is switched into the pressure buildup position.

The controlling of the two conduits A, B or brake cylinders by the controlling and regulating unit 72 takes place individually and separately, so that, for example, a reduction of the braking pressure PA becomes possible during phase II in conduit A while simultaneously the braking pressure PB in conduit B is further increased. For this purpose, the two solenoid control valves 10, 12 are switched in opposite directions; that is, the solenoid control valve 10 of conduit A is in the pressure reduction position and simultaneously the solenoid control valve 12 of conduit B is in its pressure buildup position illustrated in FIG. 1.

In the second embodiment of the invention according to FIG. 3, the parts remaining the same and having the same effect with respect to the preceding example are marked by the same reference numbers. In contrast to the latter, the otherwise unchanged valve unit contains an additional solenoid control valve 76 as the 3/2-way valve, which is connected in front of the two solenoid control valves 10, 12 of conduit A and B and is integrated in a housing 78 accommodating the valve unit 2. The additional solenoid control valve 76 is connected via a compressed-air pipe 80 on the input side with the service brake valve, which is not shown in FIG. 3 for reasons of scale, or a compressed-air pipe, which can be coupled, for the control pressure when a trailer is used, and is connected on the output side by way of a compressed-air pipe 82 with one input 50, 52 respectively of a solenoid control valve 10, 12 as well as, by means of another compressed-air pipe 84, with the compressed-air reservoir 22, and is controlled by way of an electric line 86 by the controlling and regulating unit 72. In the non-energized spring-loaded normal position according to FIG. 3, the additional solenoid control valve 76 switches the control pressure present in the pipe 80 through to the connections 50, 52 of the two solenoid control valves 10, 12, while, in the energized condition, it connects these connections 50, 52 with the compressed-air reservoir 22. The two solenoid control valves 10, 12 assigned to the relay valves 6, 8 can therefore, together with the only one additional solenoid control valve 76, connect the control input 14, 16 of the respective relay valve 6, 8 with the bleeding system 28, with the control pressure 80 or with the compressed-air reservoir 22. Independently of the control pressure 80 and as a function of a wheel slip occurring, for example, during an acceleration, the additional solenoid control valve 76 is actuated by the controlling and regulating unit 72 and is preferably integrated in the valve unit 2.

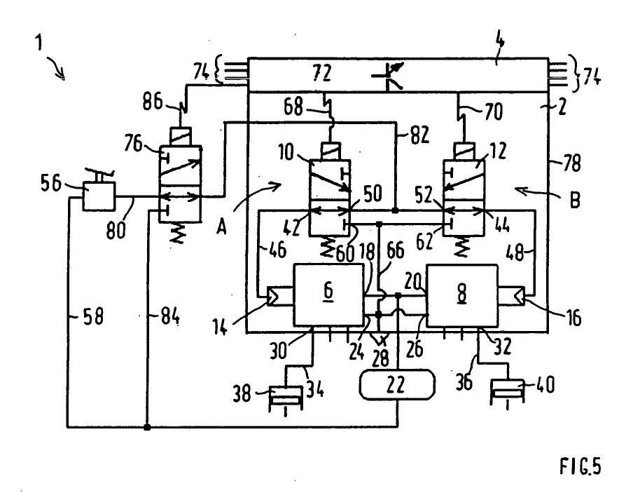

In the form of a diagram, FIG. 4 illustrates the course of the brake pressure PB and the rotational speed v_{B} of a driven wheel which, during acceleration, is initially spinning and is braked by the ASR function integrated in the pressure regulator module 1 according to FIG. 3, to which wheel, for example, conduit B of the pressure regulator module 1 is assigned, in comparison to the brake pressure p_{A} and the rotational speed v_{A} of a wheel which is also driven but does not slip in an unacceptable manner and is assigned to conduit A. The controlling and regulating unit 72 detects the spinning wheel by a comparison of the speeds v_{A} and v_{B}. If, as in the present case, the wheel assigned to conduit B has a higher speed than the wheel of conduit A, the controlling and regulating unit 72 controls the valve unit 2 in order to control brake pressure into the brake cylinder 40 of the spinning wheel for transmitting driving torque onto the wheel with the better traction by braking the spinning wheel.

Specifically, for this purpose, the additional solenoid control valve 76 and the solenoid control valve 10 assigned to the non-slipping wheel of conduit A are energized, as illustrated particularly in the center bar diagram of FIG. 4, in which an energizing is marked with the number “1” and the currentless condition is marked by the number “0”. As a result, compressed air from the compressed-air reservoir 22 arrives in the brake cylinder 40 of the spinning wheel for braking it. The braking pressure p_{B} controlled into the brake cylinder 40 of the spinning wheel of conduit B is then regulated as a function of the slip rate of the spinning wheel and of the change of speed of this wheel, in that the solenoid control valve 12 assigned to the spinning wheel is alternatingly switched back and forth between the pressure buildup position and the pressure reduction position, as illustrated particularly in the lower bar diagram of FIG. 4. As a result, the wheel speed v_{B} of the spinning wheel approaches the speed v_{A} of the non-spinning driving wheel.

In the embodiment of FIG. 5, the additional solenoid control valve 76 is not integrated into the housing 78 accommodating the valve unit 2 according to FIG. 3, but is arranged outside of this housing 78. More precisely, the additional solenoid control valve 76 is arranged outside the housing 78 accommodating the remaining valve unit 2 consisting of the two relay valves 6, 8 and the assigned solenoid control valves 10, 12, and is constructed to be connectable to the valve unit 2. It is shown that the remaining valve unit 2 accommodated in the housing 78 corresponds to that of the embodiment of FIG. 1. For this purpose, the additional solenoid control valve 76 is only connected between the service brake valve 56 and the two solenoid control valves 10, 12 and is connected by way of an electric line 86 to the controlling and regulating unit 72 and by means of a compressed-air pipe 84 to the compressed air reservoir 22. Then, as a result of the connection of the additional solenoid control valve 76 to the pressure regulator module 1 according to FIG. 1, the already existing ABS functionality can be supplemented by ASR functions.

However, the embodiments according to FIGS. 3 and 5 can also be used in an electronically monitored rollover protection system. Such system can be integrated in an ABS system and, in addition to corresponding software, requires in principle only additional information concerning the momentary lateral acceleration and a valve construction according to FIG. 3 or FIG. 5. By assessing the measured or calculated lateral acceleration for the momentary driving speed, the electronic controlling and regulating unit 72 can detect a possible overturning risk early, for example, during cornering at an excessive speed. By activating the 3/2 solenoid control valve 76 and the individual controlling of the control valves 10 and 12 connected on the output side, independently of the driver's reaction, as a result of an automatic anti-lock braking of the corresponding vehicle, the driving speed can be reduced and a possible overturning risk can thereby be eliminated.

Such a rollover protection system is particularly effective in a trailer vehicle because, first, the turnover risk itself, as a rule, originates from the trailer and, second, as mentioned above, few additional expenditures are required for an ABS system.

When a lateral acceleration sensor is integrated in the electronic controlling and regulating unit 72 and the valve unit 72 is constructed according to FIG. 3 or FIG. 5, not only is a very compact unit obtained, but the wiring and mounting expenditures are also minimized.

Table of Reference Numbers

| | |
|---|---|
| 1 | pressure regulator module |
| 2 | valve unit |
| 4 | electronic unit |
| 6 | relay valve |
| 8 | relay valve |
| 10 | solenoid control valve (pressure regulating valve) |
| 12 | solenoid control valve (pressure regulating valve) |
| 14 | control input |
| 16 | control input |
| 18 | connection |
| 20 | connection |
| 22 | compressed-air reservoir |
| 24 | output |
| 26 | output |
| 28 | bleeding system |
| 30 | working connection |
| 32 | working connection |
| 34 | brake line |
| 36 | brake line |
| 38 | brake cylinder |
| 40 | brake cylinder |
| 42 | connection |
| 44 | connection |
| 46 | compressed-air pipe |
| 48 | compressed-air pipe |
| 50 | connection |
| 52 | connection |
| 54 | compressed-air pipe |
| 56 | service brake valve |
| 58 | compressed-air pipe |
| 60 | connection |
| 62 | connection |
| 66 | bleeding pipe |
| 68 | electric line |
| 70 | electric line |
| 72 | controlling and regulating unit |
| 74 | connections |
| 76 | solenoid control valve |
| 78 | housing |
| 80 | compressed-air pipe |
| 82 | compressed-air pipe |
| 84 | compressed-air pipe |
| 86 | electric line |

1-12. (canceled)

13. A pressure regulator module for a vehicle pneumatic braking system for a wheel-slip-dependent controlling or regulating of braking pressures applied to two separate working connections, the pressure regulator module comprising:
a two-way valve assembly including one relay valve, respectively, for each conduit, each relay valve having a control input;
wherein, a respective solenoid control valve in the form of a 3/2-way valve having two switching positions is assigned to the control input of each relay valve without inserting additional valves;
wherein the solenoid control valves, together with only one additional solenoid control valve coupled on an input side of the module, connect the control input of the respective relay valve with at least one of a bleeding system, a control pressure, and a compressed-air reservoir.

14. The pressure regulator module according to claim 13, wherein the solenoid control valves are controlled independently of one another by an electronic controlling and regulating unit, and are connected on the input side with the control pressure and on an output side, in each case, with the control input of the assigned relay valve and with the bleeding system.

15. The pressure regulator module according to claim 14, wherein in a non-energized spring-loaded normal position, the solenoid control valves switch the control pressure through to the control inputs of the relay valves and, in an energized position, switch the control inputs of the relay valves through to the bleeding system.

16. The pressure regulator module according to claim 15, wherein, for holding the pressure at the working connection of a respective conduit, the assigned solenoid control valve is alternatingly switched back and forth in a pressure buildup position and a pressure reduction position by the controlling and regulating unit.

17. The pressure regulator module according to claim 14, wherein the only one additional solenoid control valve is formed by an additional 3/2-way valve, which is controlled by the electronic controlling and regulating unit and which is connected on the input side with the control pressure and with the compressed-air reservoir, and on the output side with inputs of the two solenoid control valves.

18. The pressure regulator module according to claim 15, wherein the only one additional solenoid control valve is formed by an additional 3/2-way valve, which is controlled by the electronic controlling and regulating unit and which is connected on the input side with the control pressure and with the compressed-air reservoir, and on the output side with inputs of the two solenoid control valves.

19. The pressure regulator module according to claim 16, wherein the only one additional solenoid control valve is formed by an additional 3/2-way valve, which is controlled by the electronic controlling and regulating unit and which is connected on the input side with the control pressure and with the compressed-air reservoir, and on the output side with inputs of the two solenoid control valves.

20. The pressure regulator module according to claim 17, wherein, in a non-energized spring-loaded normal position, the only one additional solenoid control valve switches the control pressure through to the inputs of the two solenoid control valves, and in an energized position, switches inputs of the two solenoid control valves through to the compressed-air reservoir.

21. The pressure regulator module according to claim 20, wherein the only one additional solenoid control valve is operated independently of the control pressure and as a function of a wheel slip occurring during an acceleration or of a lateral acceleration.

22. The pressure regulator module according to claim 21, wherein the only one additional solenoid control valve is integrated in a housing accommodating the valve assembly.

23. The pressure regulator module according to claim 21, wherein the only one additional solenoid control valve is arranged outside a housing accommodating the remaining valve assembly consisting of the two relay valves, and the assigned solenoid control valves, and is constructed to be connectable to this valve assembly.

24. The pressure regulator module according to claim 13, wherein center axes of the two relay valves are arranged coaxially and horizontally in the module.

25. The pressure regulator module according to claim 14, wherein an acceleration sensor is provided for detecting a lateral acceleration, which sensor is integrated in the electronic unit.

26. A pressure regulator module for a pneumatic braking system of a utility motor vehicle, the pressure regulator module comprising:
a two-way valve assembly having two conduits, a first conduit including a first relay valve and only one pressure regulating valve in the form of a 3/2-way valve, which 3/2-way valve is assigned to a control input of the first relay valve, and a second conduit including a second relay valve and only one second pressure regulating valve in the form of a 3/2-way valve assigned to a control input of the second relay valve; and
wherein the first and second pressure regulating valves, together with only one additional pressure regulating valve coupled with an input side of the first and second pressure regulating valves, connect a control input of the respective first and second relay valves with a bleeding system, a control pressure, or a compressed-air reservoir.
